(19) United States
(12) Patent Application Publication
(10) Pub. No.: US 2007/0250385 A1
(43) Pub. Date: Oct. 25, 2007

(54) COUPONS AND THE LIKE SYSTEMS AND METHODS

(76) Inventor: Robert Young, Bel Air, MD (US)

Correspondence Address: WATCHSTONE P+D, PLC, 1250 CONNECTICUT AVENUE, N.W., SUITE 700, WASHINGTON, DC, 20036-2657, US

(21) Appl. No.: 11/696,598

(22) Filed: Apr. 4, 2007

Related U.S. Application Data
(60) Provisional application No. 60/744,223, filed on Apr. 4, 2006.

(51) Int. Cl. G06Q 30/00; G06F 17/00

(52) U.S. Cl. 705/14; 235/375

(57) ABSTRACT

According to some embodiments, a method for generating coupons includes: providing a computer interface within a retail store at least one location prior to a consumer's walking proximate retail items in said retail store, wherein said computer interface includes an interface at which a user and enter information and a display for presenting information to the user; providing the user with a smart card or other identification means, such as, e.g., a telephone number, user ID or the like by which the user can identify the user at said computer interface; upon the user's identification of the user, the system presenting to said user via said computer interface at least one query to which the user can respond such as to cause said system to generate at least one coupon to said user based on the user's response and/or based on the user's prior purchase history, which prior purchase history is preferably stored within a computer database that may be remote to said computer interface, whereby a user can obtain one or more coupon particular to that user after entry into said retail store, but prior to proceeding to checkout, such as, e.g., at a cashier's station or the like.

The present application claims priority to U.S. Provisional Application Ser. No. 60/744,223, filed on Apr. 4, 2007, entitled Coupon and the Like Systems and Methods of Robert Young, the entire disclosure of which is incorporated herein by reference as though recited herein in full.

### BACKGROUND

1. Field of the Invention

The present invention generally relates to a system or method for convenient use of coupons and efficiently identifying and associating discounted goods for customers.

2. Background Discussion

Many stores such as retail and grocery stores, offer items at discounted price or issue coupons which can be used to obtain a discounted price on an item of sale.

However, there is no system for identifying for the customer all of such items which may be the subject of a coupon, nor is there any method for identifying which items may be of interest to the customer depending on his particular preferences or even prior purchasing history.

There is a need in the art for improved systems and methods for, among other things, generating and/or presenting coupons to consumers.

### SUMMARY

The preferred embodiments improve upon existing systems and methods.

According to some embodiments, a computer system or method for generating coupons is provided as shown and described herein.

According to some embodiments, a method for generating coupons includes: providing a computer interface within a retail store at least one location prior to a consumer's walking proximate retail items in said retail store, wherein said computer interface includes an interface at which a user and enter information and a display for presenting information to the user; providing the user with a smart card or other identification means, such as, e.g., a telephone number, user ID or the like by which the user can identify the user at said computer interface; upon the user's identification of the user, the system presenting to said user via said computer interface at least one query to which the user can respond such as to cause said system to generate at least one coupon to said user based on the user's response and/or based on the user's prior purchase history, which prior purchase history is preferably stored within a computer database that may be remote to said computer interface; whereby a user can obtain one or more coupon particular to that user after entry into said retail store, but prior to proceeding to check-out, such as, e.g., at a cashier's station or the like.

According to some embodiments, a computer coupon identification system includes: a retail store, items for sale within said store, a central computer database; at least one computer interface located within said retail store and interconnected with the central database; tags associated with said items which wirelessly transmit pricing to the central database; programming in the computer interface or the central computer database capable of presenting a customer with pricing of items and presenting a discount of said pricing.

As set forth in this application and in the prior provisional application incorporated herein by reference, the preferred embodiments provide a form of consumer marketing that is new and bold. In the preferred embodiments, it is different from other coupon/sales method because, e.g., it markets to a consumer that is in the store. In the preferred embodiments, it does not rely on reading of mail or newspaper coupon reading and clipping, or saving coupons for a user's next visit to a store. Still, it should be apparent that while store and brand loyalty can be achieved with the preferred embodiments, new consumers to a given product can also be realized. According to preferred embodiments, the system can market to the consumer using a computer system—refining from prior purchases and the customer's current shopping list that the customer has given via answers through system queries. Moreover, in the preferred embodiments, the store even further has the unique opportunity to use the data received, such as, e.g. to acquire marketing contracts from manufacturers or to direct customers to the highest profit margin products.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF THE DRAWINGS

The preferred embodiments of the present invention are shown by a way of example, and not limitation, in the accompanying figures, in which:

FIG. 1 is an architectural diagram depicting some system components according to some illustrative embodiments;

FIG. 2 is another architectural diagram depicting some computer architectural components that can be employed in some illustrative embodiments;

FIG. 3 is an example flow chart of a process for obtaining information on sale items and/or coupons;

FIGS. 4 to 8 show, in brief a series of screen shots which can be presented to a user in some illustrative and non-limiting examples, via computer interfaces (e.g., with screen shots of FIGS. 4-7 being illustrative screen shots for a central or front of store computer interface according to some embodiments, and with screen shot of FIG. 8 being an illustrative screen shot for an aisle or the like located device).

In particular, FIG. 4 is an example of a welcome screen according to some illustrative embodiments;

FIG. 5 is an example of a screen displaying previously purchased categories;

FIG. 6 is an example screen of items purchased in a category selected in FIG. 5;

FIG. 7 is an example screen of a pricing list of the item selected in FIG. 6; and

FIG. 8 is an exemplary screen of the system when placed at, or within a specific aisle.

### DETAILED DESCRIPTION OF THE PREFERRED EMBODIMENTS

While the present invention may be embodied in many different forms, a number of illustrative embodiments are described herein with the understanding that the present disclosure is to be considered as providing examples of the principles of the invention and that such examples are not intended to limit the invention to preferred embodiments described herein and/or illustrated herein.

The present invention is directed to, in some embodiments, increasing the efficiency of the market to improve customer satisfaction, to increase sales, and/or to help foster healthy competition. One or more of these can be accomplished by providing a centralized computer database of items which are the subject of a coupon, discount, or sale. The centralized computer can be updated at various times or can have continuous updates as to which items are discounted.

One method for updating the computer can involve the use of a radio frequency (REF) tag. An RF tag can be attached to each item in the store, or on the cost tag of the item, wherein an item on discount can be wirelessly transmit its price and discount to the centralized computer. Therefore, the computer will always have the latest pricing and discount information which may be present in a store. This also enables a discount to be removed or added from a particular group of items at any time at the by computer control. Alternatively, the prices can be automatically entered into the coupon/discount database at the time of entering inventory and tied with the scanner at check out. In this way, when the checkout cost is updated, it will automatically be reflected in the coupon/discount database. An alternative method would be manual input into the centralized computer of pricing and/or discounts.

Embodiments of the invention also contemplate a single or comprehensive user interface in the store at a centralized location and/or a user interface at each aisle. The comprehensive interface can be a computer system connected with the centralized database and can include all the discounts and/or pricing in the store. Computers at each aisle can also have access to the centralized database for comprehensive listing, or can have its own database, but would preferably provide the discounts and pricing of the items within the aisle where the interface is located.

In some preferred embodiments, the centralized database can include history information related to prior purchases made by a consumer, such as, e.g., where consumers have a particular smart card, user ID or the like, by which consumer purchases can be identified and stored.

In some preferred embodiments, a store customer can access a user interface to find the various discounts the store may have. In some embodiments, the customer can access the computer anonymously. However, in some preferred embodiments the consumer can log in by providing a smart card, name, login number, telephone number, and/or other type of identification. By way of example, in some preferred embodiments, the customer can also insert a shopper's card.

In the preferred embodiments, the computer database includes a record of the customer's prior purchases, item preferences, category preferences, and/or other information which may indicate which sales or items the customer may historically be interested in. The computer database may also record which purchases the customer makes or which sales, coupon offerings and/or discounts the customer takes advantage of in order to generate a history.

In some embodiments, the customer can then assess which sales or discounts may be available in a number of ways.

In some embodiments, the customer may just enter in a query of which items are on sale store wide. Alternatively, the interface may provide the option for the customer to choose a merchandise group, such as frozen foods, spices, personal care, etc. Alternative embodiments may enable the customer to search by manufacturer, food category or brand name. Alternative searches may include what the least cost item is, or which items in the store have a coupon that day. In some embodiments, the computer system will then identify the items of interest depending on the customer's search or history or both the customer's search and history and direct the customer to where the item is in the store. In some embodiments, based on the consumers responses to certain queries (such as, e.g., a user responding with identifications of one or more of a) product types, b) pricings, c) sales status desired (e.g., on sale)) and/or based on the consumers history of prior purchases, prior use of coupons, etc., the computer system can generate one or more coupon, which coupon may be tailored to that users interests. As a result, the system can advantageously present different coupons and/or discounts and/or product offerings to different users based on circumstances particular to such users and/or based on responses of such users.

An example of the practice of some embodiments of the invention can be illustrated by customer A and a customer B. If customer A enjoys a certain type of dog food brand, such as a wet dog food brand, the customer can insert a shopper's card, and the interface can display the brands that are on sale which customer A has historically preferred based on prior shopping experience. Customer B may have no preference regarding wet or other types of dog food. However, after accessing the interface, customer B may merely request the type of dog food on sale that day. The computer system can then search which items are on sale, and then display them on the interface for Customer B to choose from. Customer B can then make his choice, and can be directed to the place where the item is on sale. In this manner, brand loyalty for customer A can be re-emphasized and alternatively, for customers such as customer B can be encouraged to switch brands or become loyal to a particular brand.

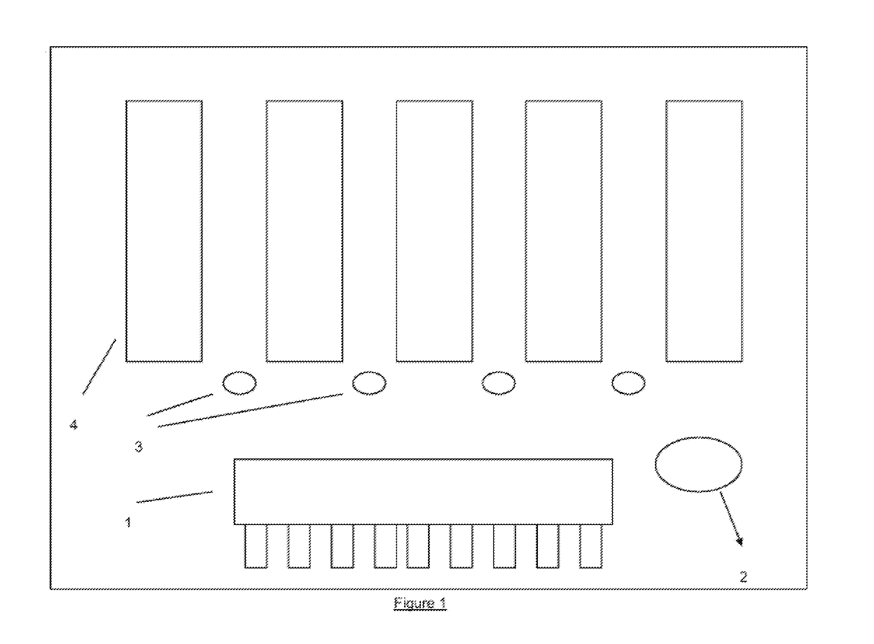

One embodiment of the invention can be seen in FIG. 1. FIG. 1 displays a grocery store with checkout counters 1 toward the front of the store. Aisles 4 are positioned toward the back of the store. A comprehensive customer user interface 2 is positioned toward the front of the store. Furthermore, aisle customer interfaces 3 can be seen positioned near each aisle for service of the items in that particular aisle. Customers can enter the store and access the interfaces 2 or 3 to determine which items are on sale or that are the subject of a coupon. Although only one comprehensive customer user interface 2 is illustrated in this figure, it should be noted that multiple comprehensive customer user interfaces 2 can be incorporated into the disclosed system. The number and positioning would be dependent upon the size and type of store as well as the number of customers per day.

The preferred embodiments of the invention can be implemented on one or more computer(s) and/or one or more network of computer(s), such as a local area network (LAN), a wide area network (WAN), the Internet and/or another network. By way of example, in some embodiments, the computer interfaces can include client computers that communicate remotely to a central server, which can include, in some examples, a central database. In various embodiments, one or more server(s), client computer(s), application computer(s) and/or other computer(s) can be utilized to implement one or more aspect of the invention Illustrative computers can include, e.g.: a central processing unit; memory (e.g., RAM, etc.); digital data storage (e.g., hard drives, etc.); input/output ports (e.g.; parallel and/or serial ports etc.); data entry devices (e.g., key boards, etc.); etc. Client computers may contain. In some embodiments, browser software for interacting with the server(s), such as, for example, using hypertext transfer protocol (HTTP) to make requests of the server(s) via the Internet or the like.

In some preferred embodiments, the system utilizes relational databases, such as, edges employing a relational database management system (RDBMS) program to create, update and/or administer a relational database. The RDBMS may take Structured Query Language (SQL) statements entered by a user or contained in an application program and create, updates and/or provides access to database(s). Some illustrative RDBMS's include ORACLE's database product line and IBM's DB2 product line. In some illustrative embodiments, one or more client computer can be provided, which can include separate client systems, LAN-based systems, and/or various other client systems. The client computer(s) can include an appropriate operating system, such as, for example, WINDOWS NT or another system. In preferred embodiments, the system is adapted to provide an object based graphical user interface (GUI).

In some preferred embodiments, the system provides a multi-user client server system. In some preferred embodiments, users are provided with a graphical user interface that is presented to the users via a plurality of client computers, which may be distributed in a single store or across multiple stores in some embodiments. In some embodiments, the graphical user interface enables the importing and/or exporting of data or information.

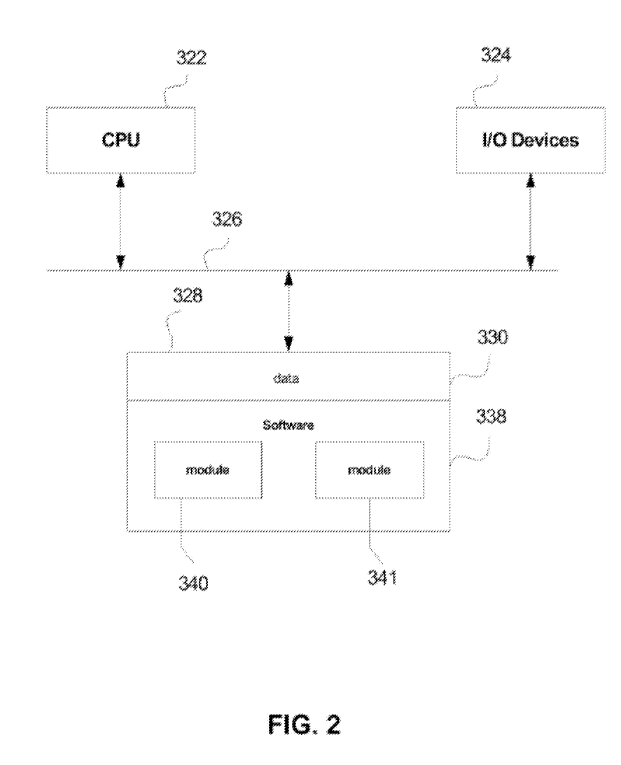

FIG. 2 shows an illustrative computer 220 that can be used to implement computerized process steps in some embodiments of the invention. In some embodiments, the computer 220 includes a central processing unit (CPU) 222, which can communicate with a set of input/output (I/O) device(s) 224 over a bus 226. The I/O devices 224 can include, for example, a keyboard, mouse, video monitor, touch screen, printer, and/or other devices.

The CPU 222 can communicate with a computer readable medium (e.g., conventional volatile or non-volatile data storage devices) 228 (hereafter “memory 228”) over the bus 226. The interaction between a CPU 222, 1/O devices 224, a bus 226C and a memory 228 can be like that known in the art. Memory 228 can include, in some examples, calendar data, event data and/or other data 230. The memory 228 can also store software 238. The software 238 can include a number of modules 240 for implementing the steps of processes, Conventional programming techniques may be used to implement these modules. Memory 228 can also store the above and/or other data file(s).

In some embodiments, the various methods described herein may be implemented via a computer program product for use with a computer system. This implementation may, for example, include a series of computer instructions fixed on a computer readable medium (e.g., a diskette, a CD-ROM, ROM or the like) or transmittable to a computer system via and interface device, such as a modem or the like. The medium may be substantially tangible (e.g., communication lines) and/or substantially intangible (e.g., wireless media using microwave, light, infrared, etc.). The computer instructions can be written in various programming languages and/or can be stored in memory device(s), such as semiconductor devices (e.g., chips or circuits), magnetic devices, optical devices and/or other memory devices. In the various embodiments, the transmission may use any appropriate communications technology.

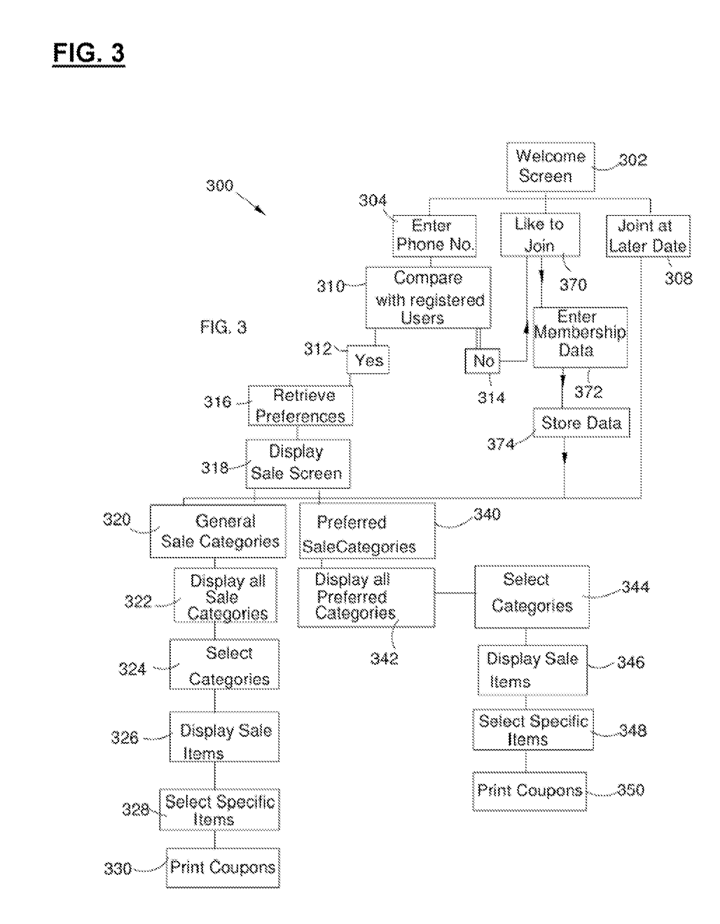

In FIG. 3 a flow chart 300 of an illustrative and non-limiting exemplary system is illustrated. A welcome screen is shown at 302. In that screen, the customer is provided with the option of entering their phone number 304, if they are a member, indicating that they would like to join 370 or indicating that they will join at a later date 308. In the system as illustrated, if a customer does not wish to join, they are taken directly to the general sale categories 320. This, however, is a preference and as an alternative the customer who does not wish to join can be prevented from accessing the system.

If a customer would like to join 370, they are asked to enter their membership data 372. The data required can be dependent upon the store and can, if so desired, include membership rules, explanation of the system etc. The entered data is then stored 374 and the customer is taken to the general sales categories screen 320. As there is no history of purchases with this customer, the preferred sale categories screen 340 will not be displayed until the next visit.

For existing customers, once the phone number is entered 304, the number is compared with registered users 310. If the customer is registered 312, the system retrieves their preferences 316 and displays the sale screen 318. The display screen 318 provides the customers with the choice of selecting general sale categories 320, which shows all items on sale or that have a coupon, or the preferred sale categories 340, which shows items that have been previously purchased that are on sale or have a coupon.

When all sale categories are displayed 322, the customer selects the categories of interest and the sale items are displayed 326. The customer then selects the specific items 328: printing coupons 330 when available.

For customers who have a purchasing history and selected the preferred sale categories 340: all categories that have items that have been previously purchased are displayed 342. The customer then selects the categories 344 of interest, thereby displaying the sale items 346. The specific items are then selected 348 and coupons printed where applicable 350.

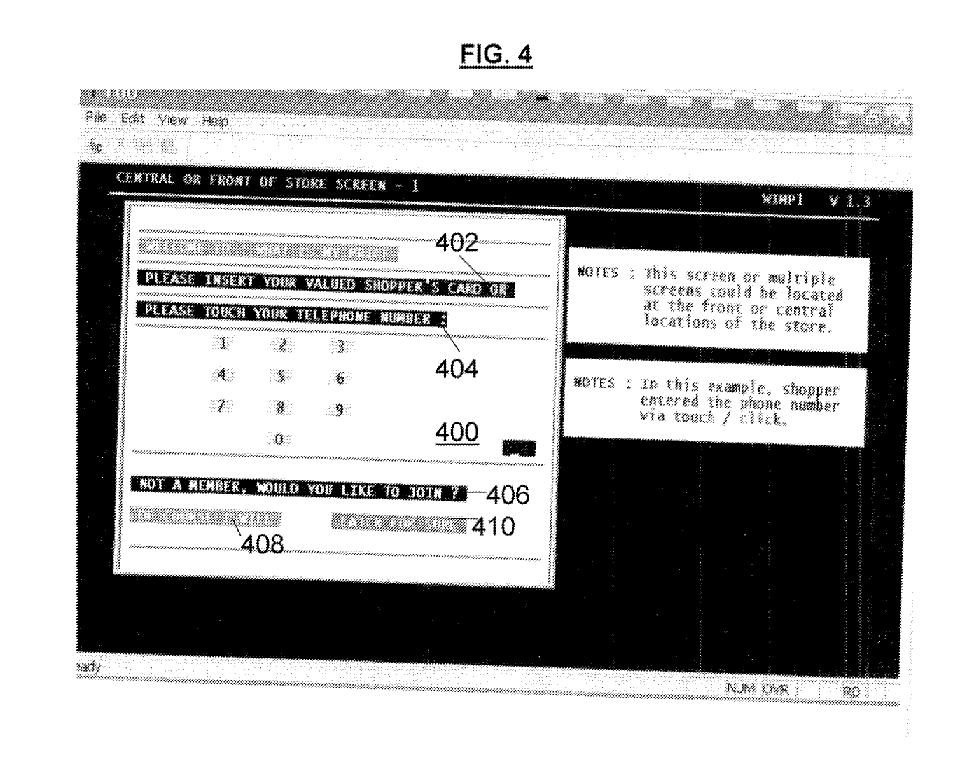

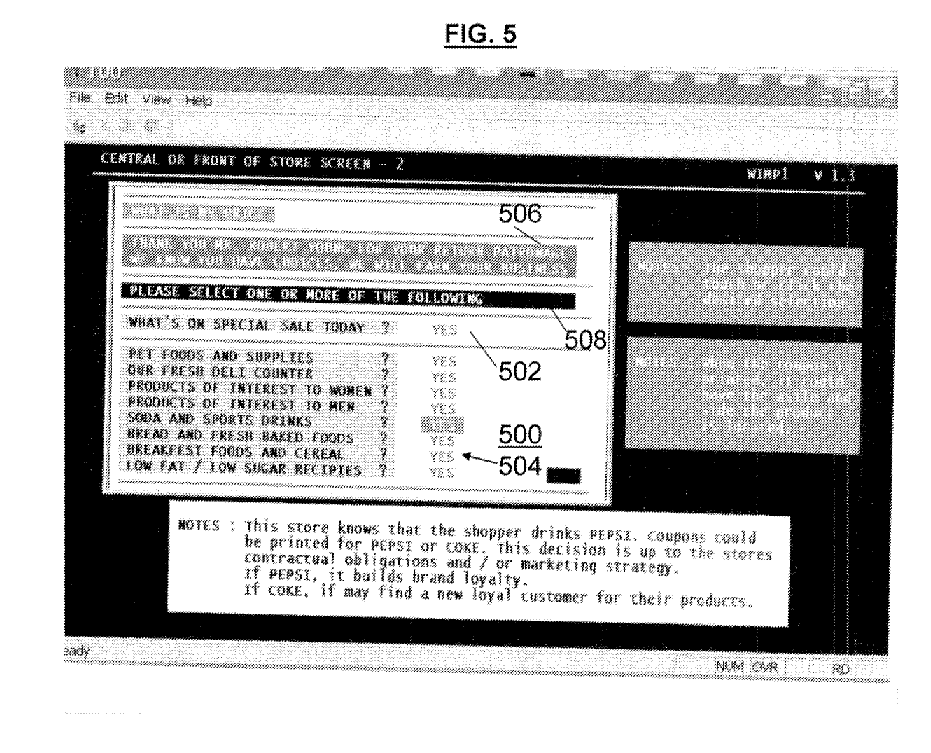

Some exemplary screen shot are illustrated in FIGS. 4-8. These screen shots do not necessarily coincide with the illustrative flow chart of FIG. 3. In FIG. 4, the Welcome screen 400 is illustrated wherein the system is provided with a card reader (now shown). The customer has the option of inserting their shopper's card 402 or entering their phone number 404. Once either the card 402 is inserted or the phone number 404 entered, the system verifies their membership and moves to FIG. 5. The welcome screen 400 also asks if the customer, if not a member, would like to join 406, providing both a “yes” option 408 and a “no” option 410. As stated above, the “no” option can either permit the customer to access the system or require that the customer become a member prior to entry into the system.

In FIG. 5, the selection screen 500 preferably acknowledges the person's name 506 with the request to select one or more of the selections displayed below 508. The customer can have the option of selecting all special sale items or items qualifying for a coupon 502, or only items that have been pulled from prior purchases 504. The prior purchases 504 are displayed by categories and the system preferably permits the customer to select more than one category.

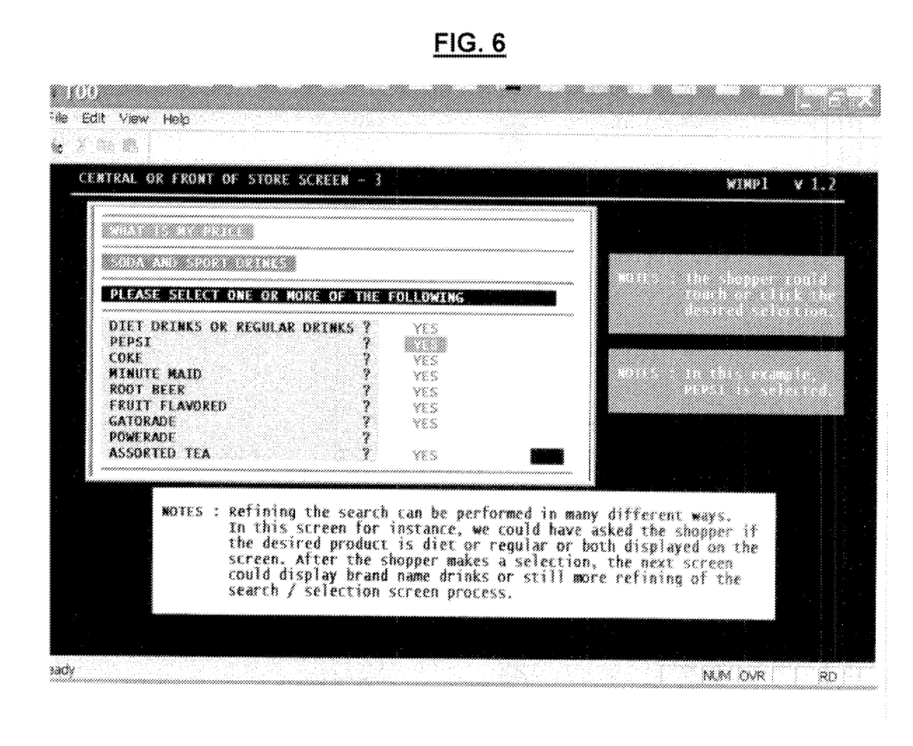

Once the categories are selected the first category is displayed as illustrated in category screen 600 of FIG. 6. The example illustrated lists multiple types of soda that are on sale or have coupons and have been previously purchased by the customer. If, for example, the customer had never purchased COKE™ this item could be eliminated from the screen, depending upon the preference of the retailer.

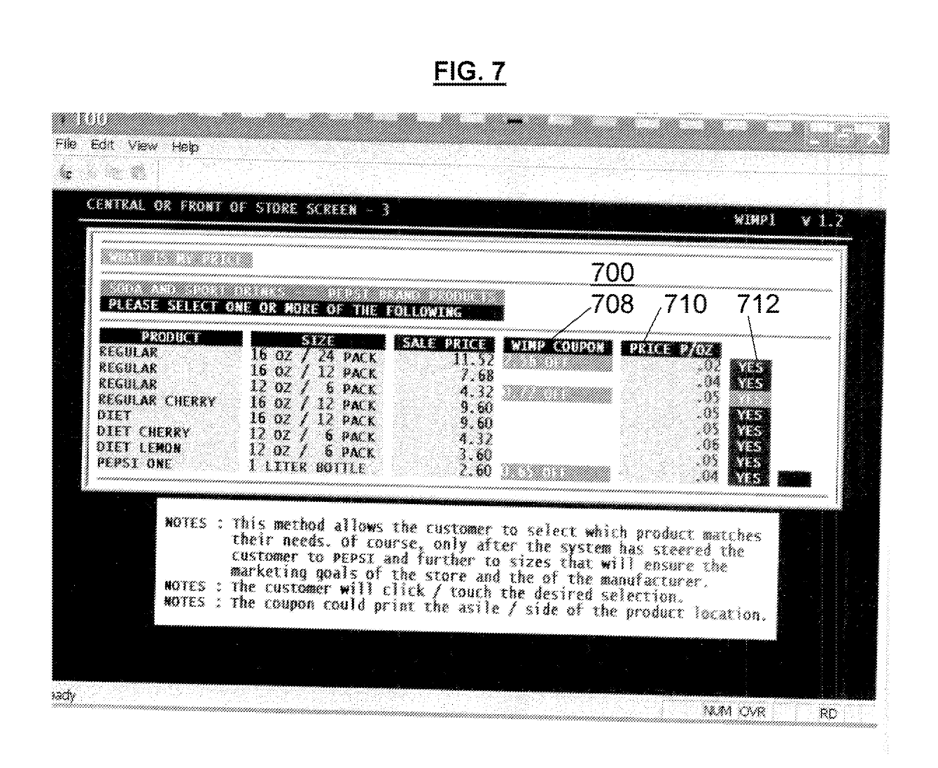

In the category screen 600, the consumer selects, PEPSI™, by way of example, as the choice for additional information, The pricing screen 700 illustrated in FIG. 7, displays all of the sizes and types of PEPSI carried at the store. Although the system can be programmed to only display sale or coupon items, a complete display enables the consumer to make the best price decision based upon their needs. As seen, the type of product 702 is displayed with the size 704. The sale price 706 is displayed with the coupon price 708. The price per ounce 710 is provided, reflecting the coupon price 708, thereby enabling the consumer to compare the soda by ounce. The consumer selects the desired coupons from the selection column 712 and the coupons are printed.

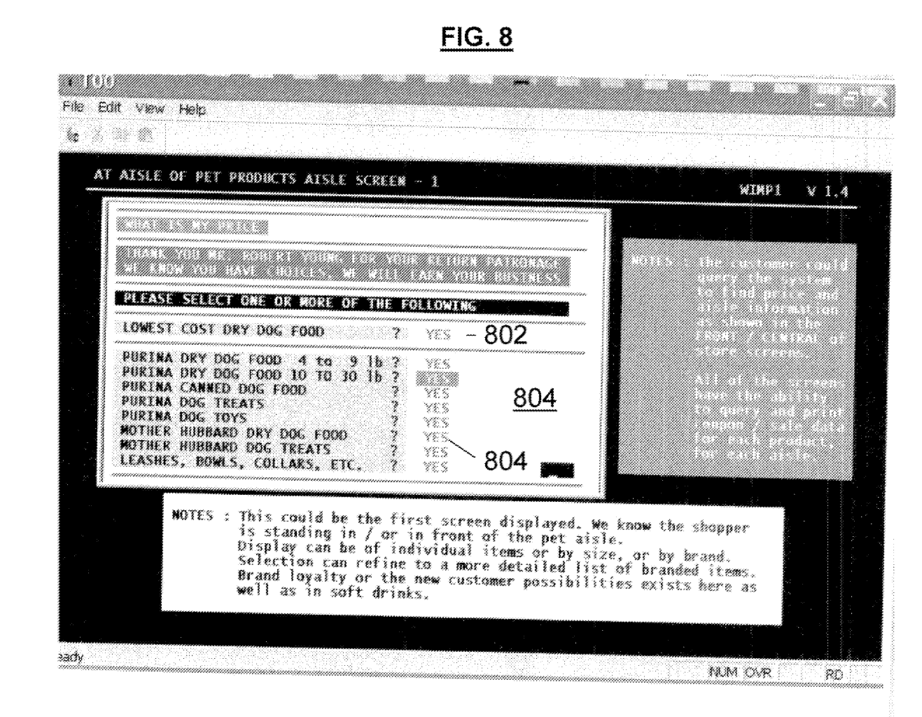

In FIG. 8, the display screen 800 reflects an illustrative initial screen displayed when the consumer is using the aisle customer interface 3. The system knows that the customer is selecting animal related items and, as the system also knows that the customer buys dog food only, displays only the dog related items. In instances where the customer buys multiple brands based on price, the display screen 800 offers the option to display the lowest cost dry dog food 802, as well as a listing of previously purchased items 804. If the customer only purchased one brand of dog products, only those products could be shown. In instances where the selection is limited to previously purchased items, the system can also provide the option to view other brands.

It is noted that the coupons can take the form of standard manufacturer's coupons or can be specifically printed for the retailer. In some embodiments, electronic coupons could be issued. When the customers access the system from the front of the store, coupons can have the location of the item, such as the aisle and side.

The data can be displayed on the screens in any manner suitable for the retailer and customer convenience. This will vary depending upon the type of store the number of items subject to coupons or sales and retailer preference.

In some alternative embodiments, the system can be accessed remotely. For example, in some embodiments, a customer can access the system via a personal computer via the Internet and/or via another network connection. By way of example, in some embodiments, a user could access the system via one's home or elsewhere, such as, e.g., via a password protected log-in on a Web Site maintained by or on behalf of the store.

In addition, in some alternative embodiments, if the customer has used a store card and selects the item from the list, this information can be transmitted directly to the central system in the store and can be credited to the customer upon checkout when his card is presented.

In addition, in some alternative embodiments, the consumer can access the system using a portable or wireless computer device, such as, e.g., a personal digital assistant (e.g., a PALM PILOT™, a BLACKBERRY™ device or the like). In some embodiments, the personal digital assistant can include a Global Positioning System in order to enable the device to identify its location, such as, e.g., being proximate the store. In some embodiments, the consumer's device is allowed to connect to the system upon being within a specific distance from the store, such as, e.g., in the parking lot, within the store or the like. In some embodiments, this can be done by employing a wireless communication with the system via a short range wireless transmission, such as, e.g., via a BLUETOOTH access or the like.

Broad Scope of the Invention:

While illustrative embodiments of the invention have been described herein, the present invention is not limited to the various preferred embodiments described herein, but includes any and all embodiments having equivalent elements, modifications, omissions, combinations (e.g., of aspects across various embodiments), adaptations and/or alterations as would be appreciated by those in the art based on the present disclosure. The limitations in the claims (e.g., including that to be later added) are to be interpreted broadly based on the language employed in the claims and not limited to examples described in the present specification or during the prosecution of the application, which examples are to be construed as non-exclusive. For example, in the present disclosure, the term “preferably” is non-exclusive and means “preferably, but not limited to.” In this disclosure and during the prosecution of this application, means-plus-function or step-plus-function limitations will only be employed where for a specific claim limitation all of the following conditions are present in that limitation: a) “means for” or “step for” is expressly recited; b) a corresponding function is expressly recited, and c) structure, material or acts that support that structure are not recited. In this disclosure and during the prosecution of this application, the terminology “present invention” or “invention” may be used as a reference to one or more aspect within the present disclosure. The language present invention or invention should not be improperly interpreted as an identification of criticality, should not be improperly interpreted as applying across all aspects or embodiments (i.e., it should be understood that the present invention has a number of aspects and embodiments), and should not be improperly interpreted as limiting the scope of the application or claims. In this disclosure and during the prosecution of this application, the terminology “embodiment” can be used to describe any aspect, features, process or step, any combination thereof, and/or any portion thereof, etc. In some examples, various embodiments may include overlapping features.

What is claimed is:

1. A computer system or method for generating coupons as shown and described herein.

2. A method for generating coupons, comprising:
providing a computer interface within a retail store at least one location prior to a consumer's walking proximate retail items in said retail store, wherein said computer interface includes an interface at which a user and enter information and a display for presenting information to the user;
providing the user with a smart card or other identification means, such as, e.g., a telephone number, user ID or the like by which the user can identify the user at said computer interface;
upon the user's identification of the user, the system presenting to said user via said computer interface at least one query to which the user can respond such as to cause said system to generate at least one coupon to said user based on the user's response and/or based on the user's prior purchase history, which prior purchase history is preferably stored within a computer database that may be remote to said computer interfaces
whereby a user can obtain one or more coupon particular to that user after entry into said retail store, but prior to proceeding to check-out, such as, e.g., at a cashier's station or the like.

3. A computer coupon identification system, comprising;
a retail store:
items for sale within said store;
a central computer database;
at least one computer interface located within said retail store and interconnected with the central database;
tags associated with said items which wirelessly transmit pricing to the central database;
programming in the computer interface or the central computer database capable of presenting a customer with pricing of items and presenting a discount of said pricing.
